(19) United States
(12) Patent Application Publication
(10) Pub. No.: US 2026/0179636 A1
(43) Pub. Date: Jun. 25, 2026

(54) MODULAR AUDIO PROCESSING SYSTEM

(71) Applicant: GOOGLE LLC, Mountain View, CA (US)

(72) Inventors: Sinan Hersek, Seattle, WA (US); Dongeek Shin, San Jose, CA (US); Francisco Rafael Malabuyo Ilagan, Redwood City, CA (US)

(21) Appl. No.: 19/424,278

(22) Filed: Dec. 18, 2025

Related U.S. Application Data
(60) Provisional application No. 63/736,287, filed on Dec. 19, 2024.

(51) Int. Cl. G10L 21/0216

(52) U.S. Cl. CPC G10L 21/0216; G10L 2021/02166

(57) ABSTRACT

Systems, methods, and computer-readable media for multi-stage audio processing using a modular model approach are disclosed. A first, device-specific model receives multi-channel audio. The first model is trained to accommodate device-specific characteristics, such as microphone geometry and acoustic properties, and processes the audio to generate an intermediate audio output. The intermediate audio may be a reduced-bandwidth or compressed representation of the captured audio. A second, universal model receives the intermediate audio. The universal model, trained on data from a plurality of different devices, processes the intermediate audio to generate a final, enhanced audio output with reduced noise and artifacts. The first model may be implemented on a resource-constrained device, such as a head-worn device, while the second model may be implemented on a paired mobile device or a remote server.

### CROSS REFERENCE TO RELATED APPLICATION

This application claims the benefit of U.S. Provisional Application No. 63/736,287, filed on December 19, 2024, the disclosure of which is incorporated herein by reference in its entirety.

### BACKGROUND

An audio processing system can enhance audio signals captured by mobile computing devices. In particular, audio enhancement techniques such as speech denoising, spatial audio capture, and sound separation can be employed to improve the quality (e.g., signal to noise ratio) of audio signals captured by mobile computing devices, such as mobile phones, virtual reality (VR) headsets, and augmented reality (AR) glasses.

Speech denoising is the process of isolating a voice of a user by suppressing or removing unwanted background sounds. A goal of speech denoising is to make the user's voice the dominant, or only, component of the final audio signal so that it can be understood by downstream applications, such as large language models (LLM) and automatic speech recognition (ASR) systems.

A machine learning model (i.e., model), such as a neural network, can be trained to enhance audio. For example, training a model to perform audio denoising may require a massive dataset to learn patterns for differentiating speech from various types of noise. Once trained, the model can apply the patterns it has learned to mathematically suppress or remove noise in audio to generate isolated speech. High quality denoising may also require the model to understand and respond to the unique physical and electronic properties that affect how a particular mobile computing device captures sound.

### SUMMARY

A modular audio processing system is disclosed that uses a device-specific model and a device-agnostic model. The device-specific model can be trained to generate an intermediate denoising result based on audio received from a particular device, and the device-agnostic model can be trained to generate a final denoising result based on the intermediate denoising result. This modular approach allows multiple different devices, each with their own audio characteristics, to use the same universal model for denoising.

In some aspects, the techniques described herein relate to a method including: capturing input audio using a device; receiving the input audio at a first model configured to remove noise specific to the device; generating intermediate audio using the first model, the intermediate audio having less noise than the input audio; transmitting the intermediate audio at a second model configured to remove noise not specific to the device; and generating output audio using the second model, the output audio having less noise, than the intermediate audio.

In some aspects, the techniques described herein relate to a head-worn device including: a plurality of microphones configured to capture input audio; a processor; and a memory storing instructions that, when executed by the processor, configures the head-worn device to: receive the input audio at a first model configured to remove noise specific to the head-worn device; generate intermediate audio using the first model, the intermediate audio having less noise than the input audio; and transmit the intermediate audio to a second model configured to remove noise not specific to the head-worn device.

In some aspects, the techniques described herein relate to a non-transitory computer-readable medium including instructions stored thereon that, when executed by at least one processor, are configured to cause a device to at least: receive input audio captured by the device at a first model, the first model configured to remove noise specific to the device; generate intermediate audio using the first model, the intermediate audio having less noise than the input audio; transmit the intermediate audio at a second model configured to remove noise not specific to the device; and generate output audio using the second model, the output audio having less noise, than the intermediate audio.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 illustrates an example use of the modular audio processing system according to a possible implementation of the present disclosure.

FIG. 2 is a flowchart illustrating a modular audio processing system according to an implementation of the present disclosure.

FIG. 3 illustrates details of the modular audio processing system of FIG. 2.

FIG. 4 is flowchart illustrating a process for training the device-specific model according to a possible implementation of the present disclosure.

FIG. 5 is a flowchart illustrating a process for training the universal model according to a possible implementation of the present disclosure.

FIG. 6 is a system block diagram of a head-worn device according to a possible implementation of the present disclosure.

FIG. 7 is a flowchart of a method for generating denoised audio according to a possible implementation of the present disclosure.

The components in the drawings are not necessarily to scale relative to each other. Like reference numerals designate corresponding parts throughout the several views.

### DETAILED DESCRIPTION

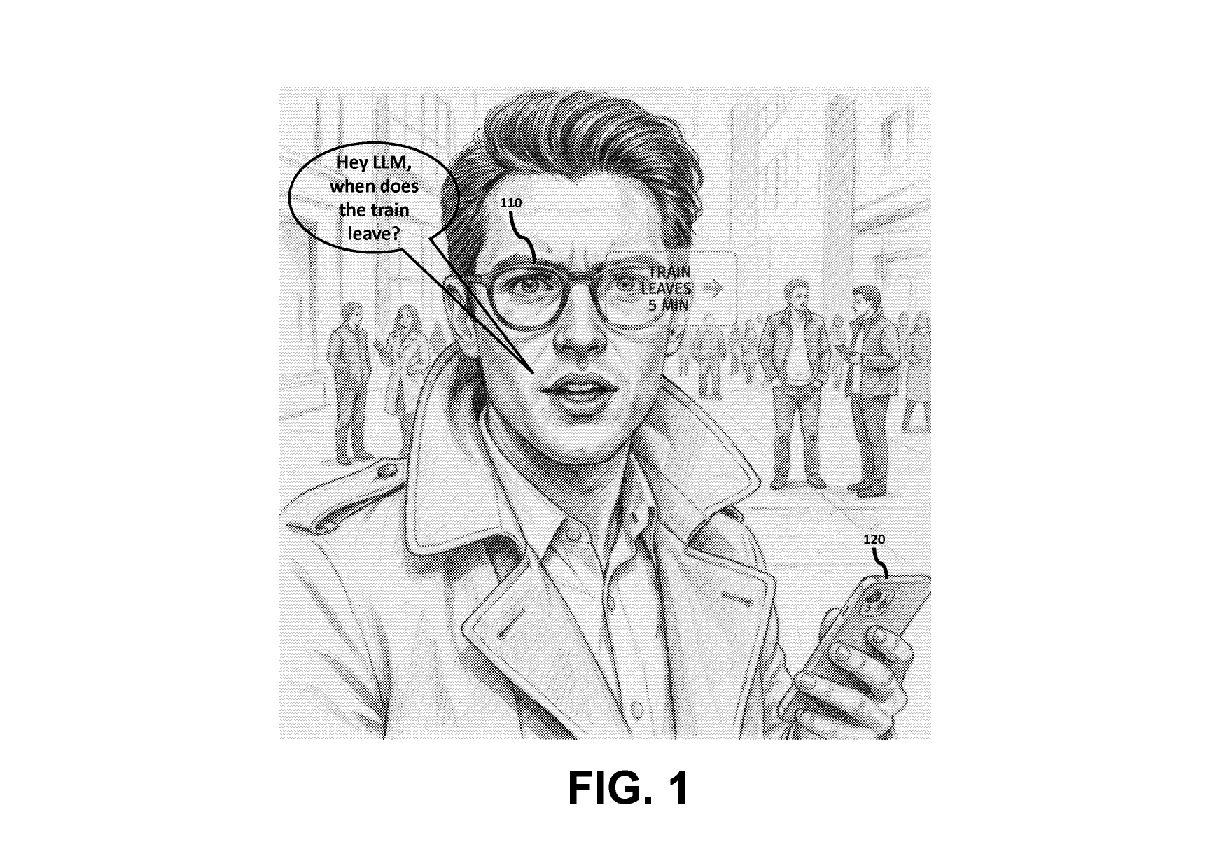

Head-worn devices, such as smart glasses, augmented reality (AR) glasses or virtual reality (VR) headsets, may detect and recognize audio (e.g., speech) to perform certain functions. As used herein, a large language model (i.e., LLM) refers to a computation model trained on extensive datasets to understand and generate human-like text or speech in response to prompts or queries. Noise in the audio captured by a head-worn device may cause errors in the detection and/or recognition of captured audio corresponding to these prompts or queries. For example, as shown in FIG. 1, a user of AR glasses 101 may wish to issue a voice command to an LLM, which is communicatively coupled to the user’s companion device 120 (e.g., mobile phone). In this scenario, a speech recognition system that processes the voice command may be severely compromised by the noise of the environment, leading to an incorrect response or a failure to understand the user's intent. Accordingly, advanced audio processing is required to ensure reliable and clear voice capture, to enable the seamless and accurate interaction with the head-worn device.

As used herein, "noise" refers to any unwanted sound or signal component that interferes with a desired audio signal. Noise may be categorized as either device-specific or not specific to a device (i.e., universal). "Device-specific noise" includes artifacts and distortions introduced by the physical and electronic characteristics of a particular capturing device. Examples of device-specific noise include electronic self-noise from a device's circuitry, distortions caused by a bandlimited microphone, or artifacts resulting from the specific geometry and beamformed profile of a microphone array. “Noise not specific to a device” refers to noise originating from the acoustic environment external to the capturing device. The "noise not specific to a device" can include environmental or ambient sounds, such as traffic noise, bystander speech, or reverberation. Audio enhancement is the reduction of noise in an audio signal so that the desired audio (i.e., audio without noise) may be detected and recognized accurately. For example, audio enhancement may generate enhanced audio that has a signal-to-noise-ratio (SNR) that is higher than noisy audio. Accordingly, a signal having “less noise” than another signal is understood to have a higher signal-to-noise ratio.

Noisy audio may be enhanced by one machine learning model (i.e., monolithic model) trained to reduce noise from the sources described above. One technical problem with this monolithic model approach is that the monolithic model must be trained on the noise characteristics for every device expected to use the model (i.e., for every device in a device ecosystem). This may result in the monolithic model being too large and/or consuming too many resources to easily be integrated with a head-worn device (e.g., smart glasses, AR glasses, AR visor, AR goggles, VR headset, etc.). Another technical problem with this monolithic model approach is that updates to the device ecosystem (e.g., new devices, new device type, device model updates, etc.) require retraining the monolithic model, which can be time-consuming and expensive. A technical solution to, at least, these technical problems, is a modular model approach which includes two models (i.e., dual-models). The dual models include (i) a device-specific model (i.e., first model), which can be used by a device to accommodate the unique audio characteristics of the device and (ii) a device-agnostic model (i.e. second model), which can be used by all devices in the ecosystem. The device-specific model and the device-agnostic model may also be referred to as the “device model” and the “universal model,” respectively. An audio processing system configured to provide audio enhancement utilizing the dual-models may be referred to as a “modular audio processing system.”

The modular model approach can offer several technical advantages. One technical advantage is that the universal model can be updated for all devices in the ecosystem without affecting the device-specific models for each device. Another technical advantage is that new devices can be added to the ecosystem faster because developing new device-specific models may require less time than developing a new monolithic model. Another technical advantage is that the device-specific model can be made small and power efficient allowing it to run directly on a battery-operated, head-worn device, while the universal model can run on a companion device or network (e.g., cloud), which has more processing power and no battery life concerns. Another technical advantage is that the device-specific model may reduce the bandwidth of the input audio so that it can be transmitted between the head-worn device and the companion device with existing wireless protocols (e.g., Bluetooth). Another technical advantage is that the enhancement (e.g. audio denoising) resulting from the combination of modular models may be a higher-quality than could reasonably be obtained by the monolithic model because of the added specialization provided by the device-specific model.

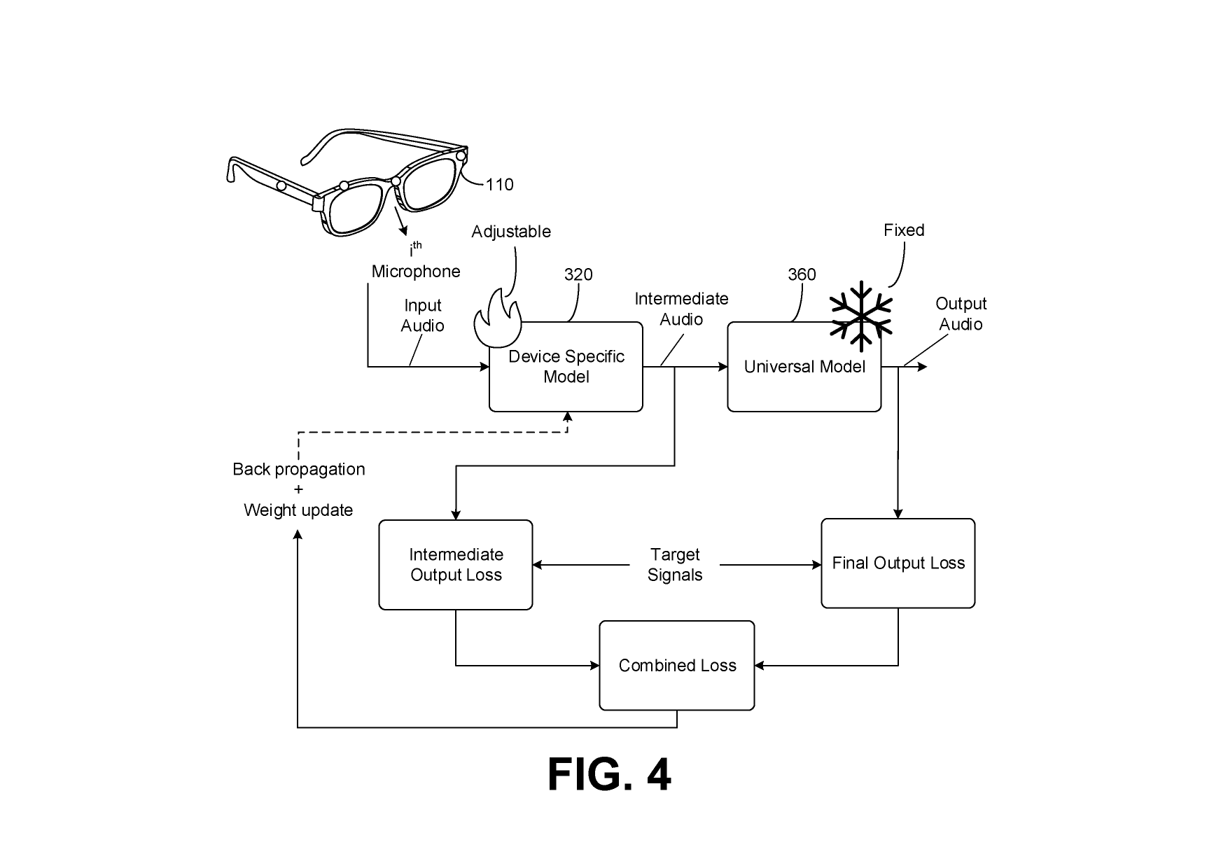

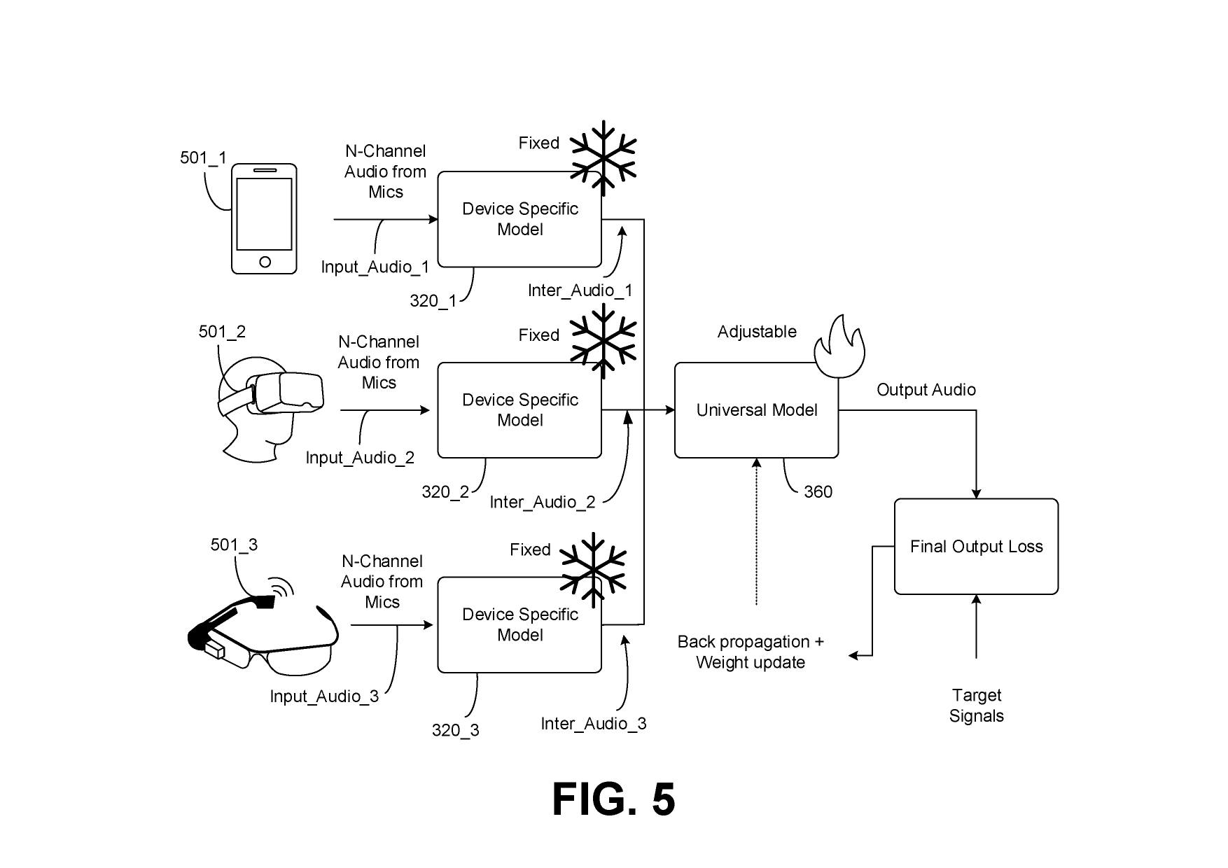

The disclosed approach also describes training methods for the models (i.e., FIGS. 4 and 5) that address a technical problem facing two-stage (e.g., dual-model) audio processing systems. The technical problem occurs when the two models in the audio processing system are trained sequentially or independently. For example, when a first model is trained without any awareness of a second model, and the second model is trained without awareness of the first model, then the audio processing system may not be easily scaled because it faces the same re-training problem as the monolithic model for a large ecosystem of devices. A cooperative method for the first model (i.e., device model) and the second model (universal model) will be described. These training methods provide technical solution to the technical problems that arise when the models are trained without consideration of each other’s training.

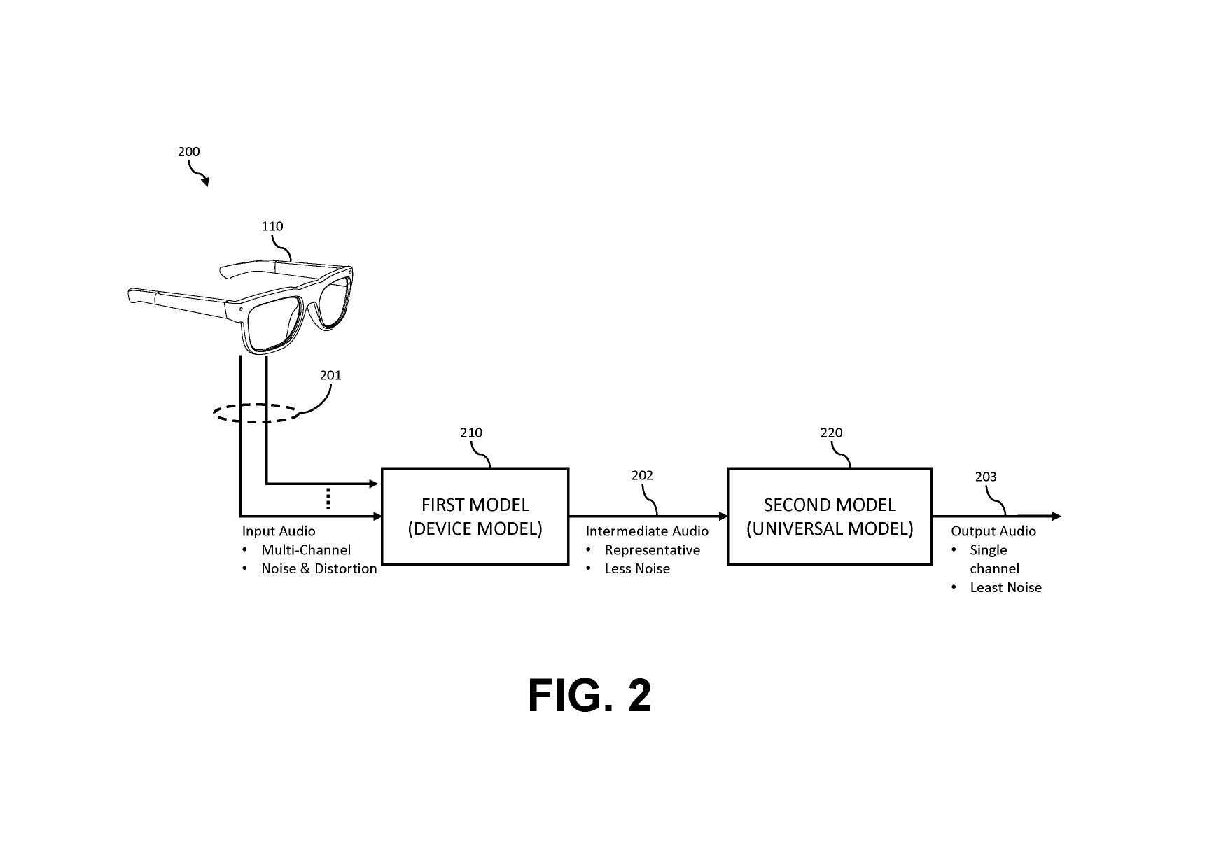

FIG. 2 is a flowchart illustrating a modular audio processing system 200 according to an implementation of the present disclosure. The system 200 begins when a head-worn device 110, or a similar device, captures input audio 201 from its environment. The input audio 201 may be multi-channel audio that includes a desired audio signal (e.g., a user's speech) as well as noise and distortion from various sources. The captured input audio 201 is provided to a first model 210 for initial processing.

The first model 210, which may be referred to as a device-specific model or device model, is configured to process the multi-channel input audio 201. The first model 210 is trained to accommodate the unique characteristics of the capturing device (i.e., the head-worn device 110), such as its microphone array geometry and acoustic properties, and removes noise that is specific to the device. The output of the first model 210 is an intermediate audio 202, which has less noise than the input audio 201. The intermediate audio 202 may also be a representative or compressed version of the input audio 201, for instance, a single-channel signal or a vector embedding, which can reduce bandwidth requirements for transmission.

The intermediate audio 202 is then transmitted to a second model 220. The second model 220, which may be referred to as a universal model, is device-agnostic and is trained to process intermediate audio from a plurality of possible devices. The second model 220 performs further enhancement on the intermediate audio 202 to remove residual noise and artifacts that are not specific to the device, such as environmental sounds. The processing by the second model 220 generates output audio 203. The output audio 203 has the least noise and represents a high-quality, enhanced version of the desired audio signal, such as the isolated speech of a user.

The modular audio processing system 200 provides a method for enhancing audio. The method begins with capturing input audio 201 using a head-worn device 110. The input audio 201, which may be multi-channel audio, is received at a first model 210. The first model 210 is configured to remove noise specific to the device 110. For example, the first model 210 may be configured based on characteristics of a microphone array of the device, such as a number of microphones, a geometry of microphones, a directivity pattern, a frequency response, and a signal-to-noise ratio. Using the first model 210, an intermediate audio 202 is generated, where the intermediate audio 202 has less noise than the input audio 201. The intermediate audio 202 may be a representation of the multi-channel audio. As used herein, a “representation of the multi-channel audio” refers to a signal or data structure that is derived from and encapsulates information from the multi-channel audio, often in a more compressed or processed form suitable for efficient transmission or further processing. Examples of such a representation include a single-channel audio signal derived from the multi-channel audio or a vector representation, such as a vector embedding, that mathematically describes features of the multi-channel audio. In some cases, the input audio 201 has an input bandwidth and the intermediate audio 202 has a reduced bandwidth that is smaller than the input bandwidth. The intermediate audio 202 is transmitted to a second model 220, which is configured to remove noise not specific to the head-worn device 110. The second model 220 generates an output audio 203, which has less noise than the intermediate audio 202. The output audio 203 may be an isolated speech of a user of the head-worn device 110, which can then be transmitted to a large language model for further processing.

While two-stage processing architectures may address the challenges of managing numerous device-specific models, some systems have explored two-stage processing architectures. In such systems, a first model or processing block performs an initial enhancement on multi-channel audio, and a second model performs a subsequent refinement. For example, some systems use a first neural network to process noisy, multi-channel speech to generate a partially enhanced signal, which is then fed into a second neural network to produce the final enhanced speech.

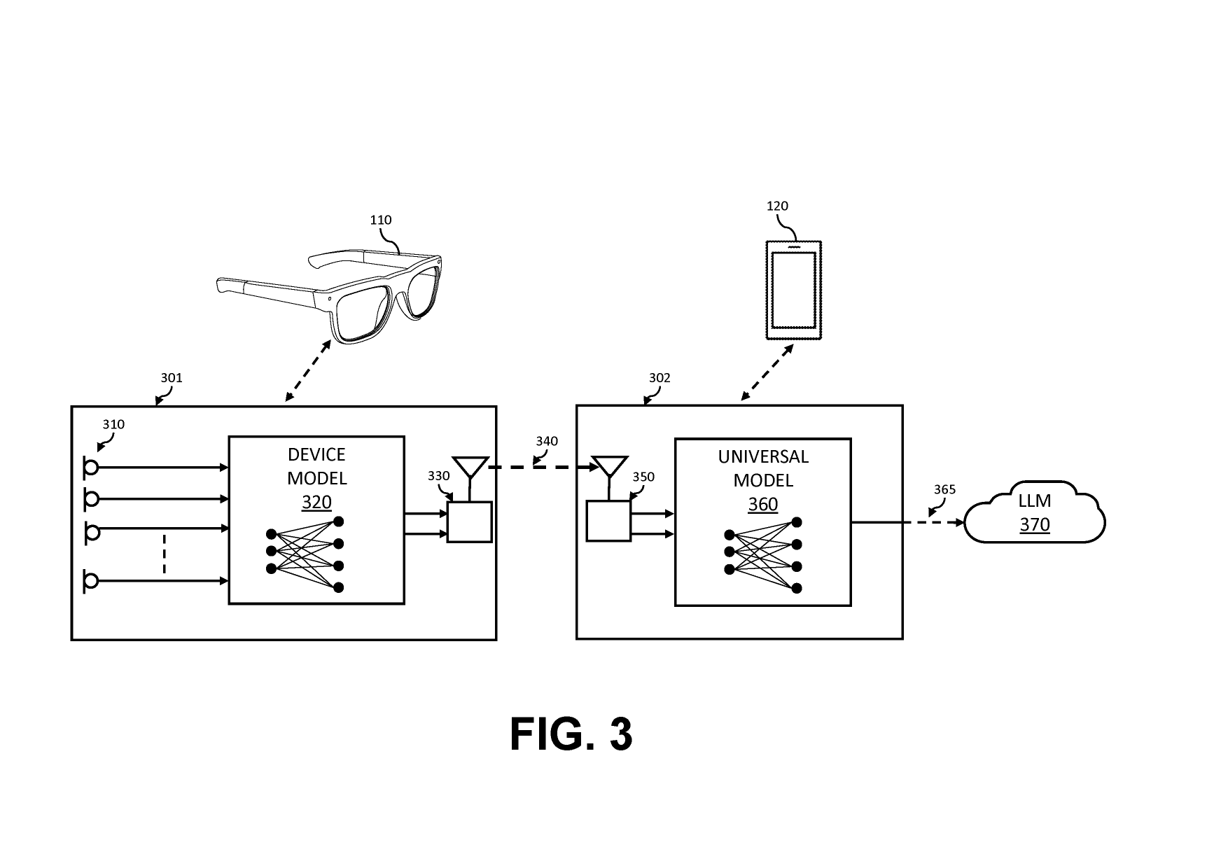

FIG. 3 illustrates details of the modular audio processing system of FIG. 2. The system architecture may be split into a device side 301 and a universal side 302. The device side 301 may include a head-worn device 110 that houses a device model 320. The universal side 302 may be hosted on a separate companion device 120, such as a smartphone, which runs a universal model 360. This split-compute architecture allows the resource-constrained head-worn device 110 to perform initial, device-specific processing, while the more powerful companion device 120 handles the subsequent, more general processing, which may require more resources.

On the device side 301, multiple audio inputs, captured by a microphone array 310 on the head-worn device 110, are fed into the device model 320. The device model 320 (i.e., first model) may be configured to remove noise specific to characteristics of the microphone array 310, which may include a number of microphones, a geometry of the microphones, a directivity pattern, a frequency response, or a signal-to-noise ratio. The device model 320, which may be a neural network, processes the multi-channel inputs to generate an intermediate audio signal. This intermediate audio may be a compressed or representative version of the input, such as a single audio channel, which has less noise and a reduced bandwidth compared to the original multi-channel audio. The intermediate audio is then provided to a communication interface 330 of the head-worn device 110, which transmits it via a wireless communication channel 340 to a communication interface 350 of the companion device 120.

On the universal side 302, the communication interface 250 of the companion device 120 receives the transmitted intermediate audio. The intermediate audio is then processed by the universal model 360. The universal model 360, which may also be a neural network, performs additional enhancement to remove residual noise and artifacts not removed by the device model 320. The output of the universal model 360 is a final, enhanced audio signal. This enhanced audio can be transmitted 365 to a downstream application, such as a large language model 370 (i.e., LLM), which may be hosted on a remote server or cloud.

In a possible implementation, the input audio captured by the microphone array 310 can be multi-channel audio, while the intermediate audio generated by the device model 320 can be a representation of the multi-channel audio. For example, the representation may include a single-channel of the multi-channel audio. The multi-channel audio can have a relatively high bandwidth, which is not suitable for the wireless communication channel 340 (e.g., Bluetooth), whereas the intermediate audio can have a relatively low bandwidth, which is suited for the wireless communication channel 340. In other words, the multi-channel audio can have a first bandwidth that exceeds a maximum data rate of the wireless communication channel, and the intermediate audio can have a second bandwidth that is less than or equal to the maximum data rate of the wireless communication channel. In a possible implementation, the universal model 360, can output an isolated speech of a user of the device, which it then transmits to a large language model 370 (e.g., artificial intelligence).

In a possible application, the modular system can be configured for spatial audio capture. In this configuration, the device-specific model 320 processes the multi-channel audio from the microphone array 310 to generate an intermediate spatial audio signal, such as a first-order ambisonic audio format. This intermediate signal captures the sound field around the device but may have minor inaccuracies. The universal model 360 then processes this intermediate signal to refine it, producing a higher-fidelity spatial audio output that more accurately represents the directionality of sounds in the environment. This enhanced spatial audio can be used for immersive playback that accompanies 3D video recordings.

FIG. 4 is flowchart illustrating a process for training the device-specific model according to a possible implementation of the present disclosure. FIG. 4 is a flowchart illustrating a process for training the device-specific model according to a possible implementation of the present disclosure. The training process may be performed with an existing universal model 360, which has a fixed set of weights and is not updated during this procedure. The device-specific model 320 has an adjustable set of weights that are updated throughout the training process. The training process begins with providing input audio, such as multi-channel audio captured by a microphone array of a head-worn device 110, to the adjustable device-specific model 320. The device-specific model 320 processes the input audio to generate an intermediate audio signal. This intermediate audio is then processed by the fixed universal model 360 to generate a final output audio.

The training process utilizes a target signal, which represents an ideal version of the desired audio (e.g., clean, isolated speech). Two separate loss calculations are performed. An intermediate output loss is determined by comparing the intermediate audio from the device-specific model 320 to the target signal to determine the degree of difference (i.e., intermediate output loss). A final output loss is determined by comparing the output audio from the universal model 360 to the same target signal to determine the degree of difference (i.e., final output loss). These two losses are then used to calculate a combined loss, which may be a weighted combination (e.g., weighted average) of the intermediate output loss (i.e., intermediate loss) and final output loss (i.e., final loss). The combined loss provides a comprehensive measure of performance, accounting for both the initial processing by the device-specific model and the final result from the complete dual-model system. The weights for the combination may be selected empirically to balance the processing burden between the models, considering factors such as specific device constraints. For example, for a pair of AR glasses with limited battery life, a higher weight may be placed on the final output loss relative to the intermediate output loss. This encourages the training process to shift more of the denoising burden to the universal model, which may be running on a companion device with more computational resources and fewer power constraints, while allowing the device-specific model on the glasses to remain small and power-efficient.

The combined loss is then used to update the adjustable weights of the device-specific model 320 through a backpropagation process. The backpropagation process is an algorithm that calculates the gradient of the combined loss and propagates it backward through the model to determine how each weight of the device-specific model 320 should be adjusted to minimize the combined loss. By using combined feedback from both the intermediate stage and the final output stage, the training process makes the device-specific model 320 aware of the downstream processing performed by the universal model 360. This cooperative training approach allows for the optimization of the device-specific model 320 to not only produce a partially enhanced signal but also to provide an input that the universal model 360 can effectively refine. This can help to balance the processing burden between the two models and may allow the device-specific model 320 to be smaller and more efficient.

As illustrated in the training process of FIG. 4, the first model (e.g., device-specific model 320) may be trained while the second model (e.g., universal model 360) has a fixed set of weights. The training of the first model can include inputting the input audio previously captured by the device into the first model, which has an adjustable set of weights. The first model may then generate a first estimate of a target audio, such as the intermediate audio. This first estimate can be processed by the fixed second model to generate a second estimate of the target audio, which may be the final output audio. The process may further include comparing the first estimate to the target audio to determine a first loss (e.g., intermediate output loss) and comparing the second estimate to the target audio to determine a second loss (e.g., final output loss). An overall loss may be determined by computing a weighted combination of the first loss and the second loss. The adjustable set of weights of the first model can then be updated based on the overall loss using, for example, a backpropagation algorithm.

FIG. 5 is a flowchart illustrating a process for training the universal model according to a possible implementation of the present disclosure. This training process is designed to make the universal model 360 robust to intermediate audio generated by a plurality of different device types. The process utilizes a collection of pre-existing device-specific models, such as a first device-specific model 320_1 for a smartphone 501_1, a second device-specific model 320_2 for a headset 501_2, and a third device-specific model 320_3 for a pair of smart glasses 501_3. During this training procedure, these various device-specific models have fixed sets of weights and are not adjusted. In contrast, the universal model 360 has an adjustable set of weights that are updated throughout the training process.

The training process begins by feeding input audio, corresponding to each device type, into the respective fixed device-specific model. For example, input audio from a smartphone (INPUT_AUD._1) is processed by the first device-specific model 320_1 to generate a first intermediate audio (INTER._AUD._1). This is repeated for other devices to create a diverse training dataset of intermediate audio signals. These intermediate audio signals, which may contain different types of residual noise and artifacts characteristic of their originating devices, are then input into the adjustable universal model 360. The universal model 360 processes the intermediate audio to generate a final output audio. A final output loss is then calculated by comparing this output audio to a corresponding target signal, which represents the ideal, noise-free audio. This process computes a loss value representing the magnitude of the difference between the model's output and the ideal target signal. For a speech denoising application, for example, the target signal may be a single-channel waveform containing only the user's speech, free of environmental noise, reverberation, and other acoustic interference. This target signal can be generated synthetically using acoustic simulations or by using recordings of isolated, clean speech.

The final output loss is used to update the adjustable weights of the universal model 360 via a backpropagation algorithm. By training on a diverse set of intermediate audio from multiple device-specific models, the universal model 360 learns to effectively remove a wide variety of residual artifacts and noise that are not specific to any single device. This method produces a robust, device-agnostic universal model that can be improved and deployed across an ecosystem of devices, potentially through over-the-air updates, to enhance audio quality for all devices without needing to retrain or modify the individual device-specific models. As more device-specific models for new devices become available, the universal model can be further retrained to be even more robust.

As illustrated in the training process of FIG. 5, the second model (e.g., universal model 360) may be trained using intermediate audio previously generated by a plurality of first models (e.g., device-specific models 320_1, 320_2, 320_3) of a plurality of devices (e.g., 501_1, 501_2, 501_3).The plurality of devices may represent an entire ecosystem of devices, and therefore the number of device-specific models used for training can be much larger than the three examples shown. While training the second model, the plurality of first models may have fixed sets of weights. The training of the second model can include inputting the intermediate audio previously generated by the plurality of first models into the second model, which has an adjustable set of weights. The second model may process the intermediate audio to generate an estimate of a target audio. A loss can be determined based on a comparison of the estimate to the target audio, and the adjustable set of weights of the second model can subsequently be updated based on the determined loss.

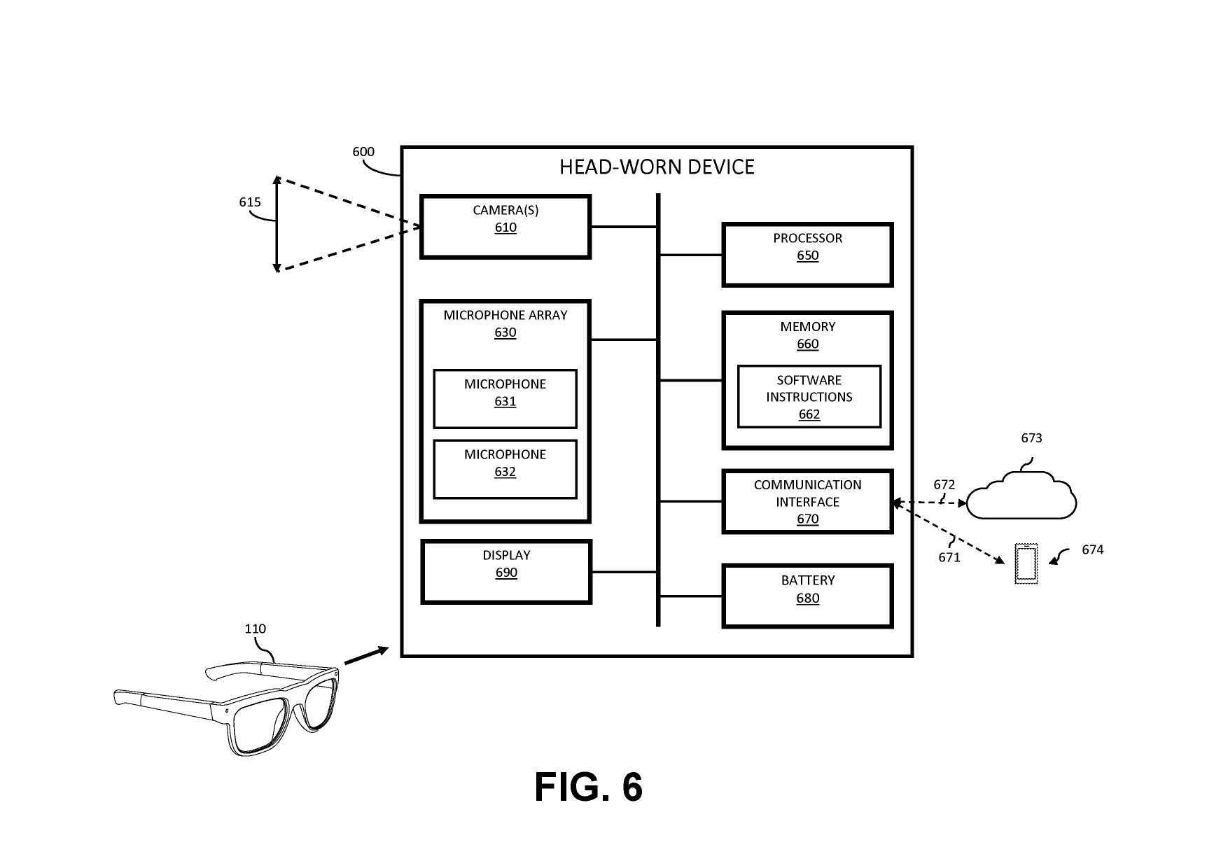

FIG. 6 is a system block diagram of a head-worn device 600 according to a possible implementation of the present disclosure. The head-worn device 600 may be an example of the head-worn device 110 in relation to FIGS. 1-3, which can be implemented as smart glasses, AR glasses, a VR headset, or other wearable computing device. The device 600 includes a plurality of components communicatively coupled via a bus, including a processor 650, a memory 660, a communication interface 670, a battery 680, a display 690, one or more cameras 610, and a microphone array 630.

The head-worn device 600 includes input components for capturing information from the user's environment. The microphone array 630 includes a plurality of microphones, such as a first microphone 631 and a second microphone 632, configured to capture multi-channel audio from the environment. This captured audio serves as the input audio (e.g., input audio 201) for the modular audio processing system. The device 600 may also include one or more cameras 610 configured to capture visual input 615, such as images or video of the surrounding environment, which may be used for AR or VR applications.

The processor 650 may be a general-purpose or special-purpose microprocessor configured to execute software instructions 662 (i.e., instructions) stored in the memory 660. The memory 660 may include volatile and/or non-volatile memory. The software instructions 662, when executed by the processor 650, configure the head-worn device 600 to perform various operations described herein. For example, the instructions 662 may cause the processor 650 to implement the first model (i.e., the device-specific model 320) to process the input audio captured by the microphone array 630 and generate the intermediate audio.

The communication interface 670 facilitates data exchange with external devices. The interface 670 may support wireless communication 672, such as Bluetooth or Wi-Fi, to connect with a remote device 674 (e.g., a companion device 120 such as a smartphone or tablet) via a communication link 671, or with a cloud network 673. In a split-compute architecture, the communication interface 670 may be configured to transmit the intermediate audio generated by the device-specific model to the remote device 674, where the second model (i.e., the universal model 360) is executed. The device 600 may also include a display 690, including a waveguide and micro-LED display, for presenting visual information to the user.

The components of the head-worn device 600 are powered by a battery 680. The integrated system of components enables the device 600 to function as the device-side 301 of the modular audio processing system. The microphone array 630 captures the input audio, the processor 650 executes the device-specific model to perform initial, power-efficient enhancement and generate intermediate audio, and the communication interface 670 transmits this intermediate audio for further processing. This architecture allows the head-worn device 600 to be lightweight and power-efficient while leveraging more powerful computational resources on a companion device or in the cloud.

The memory 660 is an example of a non-transitory computer-readable medium that includes instructions 662 stored thereon. The instructions 662, when executed by the processor 650, are configured to cause the head-worn device 600 to perform a method for generating denoised audio. The method includes receiving input audio captured by the microphone array 630 at a first model, which is configured to remove noise specific to the head-worn device 600. The instructions 662 further cause the processor 650 to generate intermediate audio using the first model, where the intermediate audio has less noise than the input audio. The head-worn device 600 is then caused to transmit the intermediate audio, via the communication interface 670, to a second model, which may be located on a remote device 674. The second model, which is configured to remove noise not specific to the head-worn device 600, then generates a final output audio that has less noise than the intermediate audio.

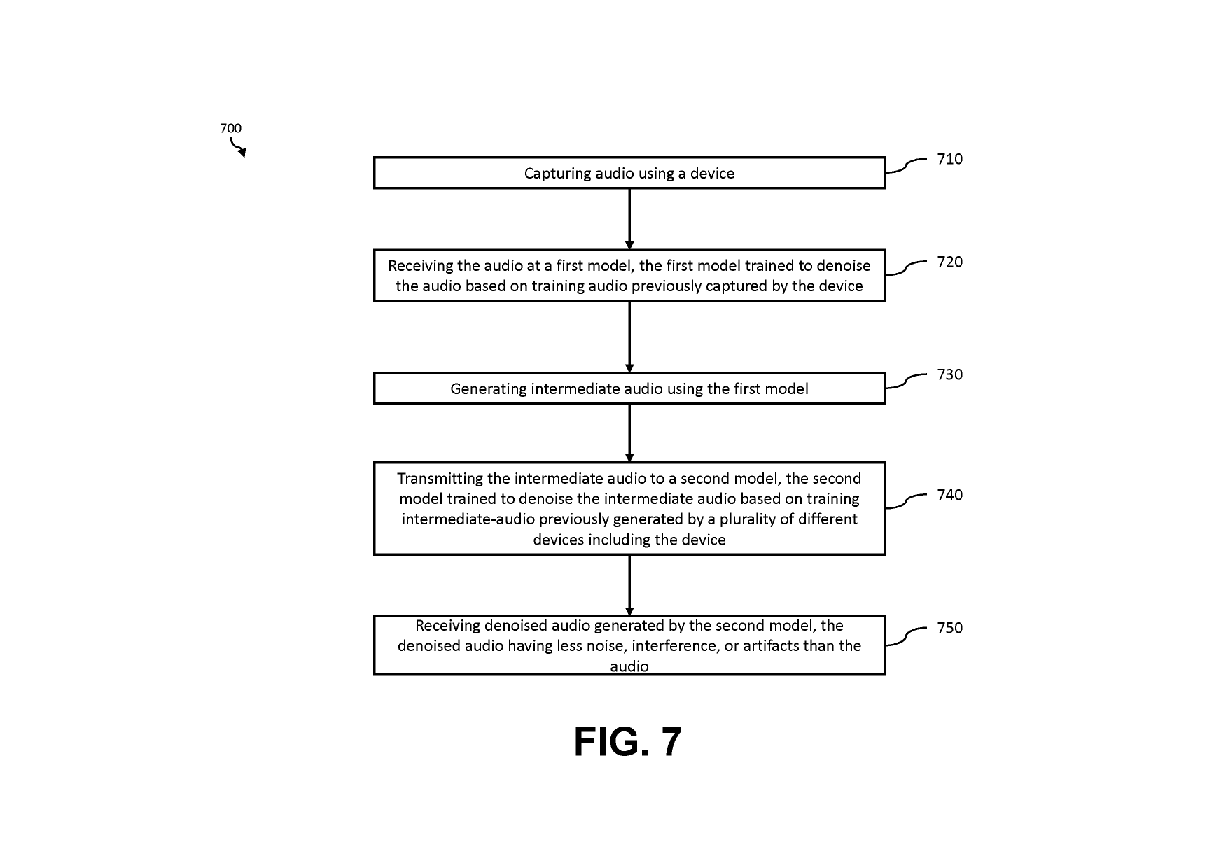

FIG. 7 is a flowchart of a method for generating denoised audio according to a possible implementation of the present disclosure. The method 700 may begin at block 710 with capturing input audio using a device, such as the head-worn device 110. The input audio may be multi-channel audio captured by a microphone array of the device. At block 720, the captured input audio is received at a first model. The first model is configured to remove noise specific to the device. For example, the first model may be trained to accommodate the unique acoustic properties and microphone geometry of the device that captured the audio.

At block 730, the method 700 continues by generating an intermediate audio using the first model. Because the first model is configured to remove device-specific noise, the intermediate audio has less noise than the input audio. At block 740, the intermediate audio is transmitted to a second model. The second model is configured to remove noise that is not specific to the device. For example, the second model may be a universal model trained to remove general environmental sounds and other artifacts from intermediate audio generated by a plurality of different devices.

At block 750, the method 700 concludes with the second model generating a final output audio. The second model processes the intermediate audio to remove residual, non-device-specific noise. As a result, the output audio generated by the second model has less noise than the intermediate audio. The final output audio may be an isolated speech signal of a user, suitable for processing by a downstream application such as a large language model.

While multi-stage audio processing systems using multiple neural networks may be used, the specific functional division, described in the disclosed approach in which device-specific noise cancellation is decoupled from universal noise cancellation provides a technical advantage of these systems. Furthermore, the disclosed cooperative training methods, where the device-specific model is trained with awareness of the downstream universal model and the universal model is trained on diverse outputs from a plurality of device-specific models, represent a departure from systems where models are trained independently or sequentially. In particular, the device-specific model is trained using a combined loss function that accounts for both its own intermediate output and the final output from the system.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

1. A method comprising:
capturing input audio using a device;
receiving the input audio at a first model configured to remove noise specific to the device;
generating intermediate audio using the first model, the intermediate audio having less noise than the input audio;
transmitting the intermediate audio to a second model configured to remove noise not specific to the device; and
generating output audio using the second model, the output audio having less noise than the intermediate audio.

2. The method according to claim 1, wherein:
the input audio has an input bandwidth; and
the intermediate audio has a reduced bandwidth, which is smaller than the input bandwidth.

3. The method according to claim 1, wherein:
the input audio is multi-channel audio; and
the intermediate audio is a representation of the multi-channel audio.

4. The method according to claim 3, wherein the representation of the multi-channel audio includes a vector representation of the multi-channel audio.

5. The method according to claim 3, wherein the representation of the multi-channel audio includes a single-channel of the multi-channel audio.

6. The method according to claim 1, wherein the output audio is an isolated speech of a user of the device.

7. The method according to claim 6, further comprising:
transmitting the isolated speech of the user to a large language model.

8. The method according to claim 1, further comprising:
training the first model on input audio previously captured by the device; and
training the second model on intermediate audio previously generated by a plurality of first models of a plurality of devices.

9. The method according to claim 8, wherein training the first model includes:
inputting the input audio previously captured by the device into the first model;
generating a first estimate of a target audio using the first model;
processing the first estimate with the second model to generate a second estimate of the target audio;
comparing the first estimate to the target audio to determine a first loss;
comparing the second estimate to the target audio to determine a second loss;
computing a weighted combination of the first loss and the second loss to determine an overall loss; and
updating an adjustable set of weights of the first model based on the overall loss.

10. The method according to claim 9, wherein the second model has a fixed set of weights while training the first model.

11. The method according to claim 8, wherein training the second model includes:
inputting the intermediate audio previously generated by the plurality of first models of the plurality of devices into the second model;
processing the intermediate audio with the second model to generate an estimate of a target audio;
determining a loss based on a comparison of the estimate to the target audio; and
updating a set of weights of the second model based on the loss.

12. The method according to claim 11, wherein the plurality of first models have fixed sets of weights while training the second model.

13. The method according to claim 1, wherein the first model is configured to remove noise specific to the device based on characteristics of a microphone array of the device.

14. The method according to claim 13, wherein the characteristics of the microphone array include any of:
a number of microphones;
a geometry of microphones;
a directivity pattern;
a frequency response; and
a signal-to-noise ratio.

15. A head-worn device comprising:
a plurality of microphones configured to capture input audio;
a processor; and
a memory storing instructions that, when executed by the processor, configures the head-worn device to:
receive the input audio at a first model configured to remove noise specific to the head-worn device;
generate intermediate audio using the first model, the intermediate audio having less noise than the input audio; and
transmit the intermediate audio to a second model configured to remove noise not specific to the head-worn device.

16. The head-worn device according to claim 15, further including a communication interface configured to transmit the intermediate audio over a wireless communication channel.

17. The head-worn device according to claim 16, wherein:
the input audio is multi-channel audio having a first bandwidth that exceeds a maximum data rate of the wireless communication channel; and
the intermediate audio is a representation of the multi-channel audio having a second bandwidth that is less than or equal to the maximum data rate of the wireless communication channel.

18. The head-worn device according to claim 15, wherein:
the first model includes a first set of weights determined from training data captured by the head-worn device; and
the second model includes a second set of weights determined from training data generated by a plurality of first models corresponding to a plurality of different devices.

19. The head-worn device according to claim 15, wherein the first model is stored, and used, on the head-worn device and the second model is stored, and used, on a mobile device.

20. A non-transitory computer-readable medium comprising instructions stored thereon that, when executed by at least one processor, are configured to cause a device to at least:
receive input audio captured by the device at a first model, the first model configured to remove noise specific to the device;
generate intermediate audio using the first model, the intermediate audio having less noise than the input audio;
transmit the intermediate audio to a second model configured to remove noise not specific to the device; and
generate output audio using the second model, the output audio having less noise than the intermediate audio.
